(19) United States
(12) Patent Application Publication
(10) Pub. No.: US 2005/0130518 A1
(43) Pub. Date: Jun. 16, 2005

(54) Embossed film with adhesive or without adhesive or laminated to bottom non-slip surface to simulate metal textures for lining shelves and drawers

(75) Inventor: William Sobonya, Westlake, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Henkel Consumer Adhesives, Inc.

(21) Appl. No.: 10/736,404

(22) Filed: Dec. 15, 2003

(51) Int. Cl. B32B 27/12; B32B 5/12; B32B 27/04; B32B 5/02

(52) U.S. Cl. 442/38; 442/43; 442/58

(57) ABSTRACT

A covering for use on a surface. The preferred covering is removable, non-slip, and non-adhesive and includes a decorative embossed vinyl film having a metal-like texture and a clear polypropylene protective layer adhered to the textured side of the embossed vinyl film. The covering includes a substrate having a front surface and a back surface. The substrate is non-slip coated. The decorative embossed film is adhered to the substrate.

This invention relates to embossed films, with adhesive, without adhesive or bonded to a non-slip bottom surface used as a covering, for example, as shelf liners.

### BACKGROUND OF THE INVENTION

Currently available coverings or liners are often adhesive sheets which are adhered with a contact-type adhesive directly to the surface to be covered. These liner products are generally offered in roll form and must be cut to proper size to fit the dimensions of a surface, such as a shelf. Once cut, the product is either adhered with the adhesive or with tacks to the shelf surface or it is simply positioned on top of the shelf, otherwise unsecured.

The benefits of using any covering such as shelf paper reside primarily in offering a decorative surface to the shelf while simultaneously providing a protective layer which will prevent damage, such as, for example, water damage to the shelf structure itself. Among the problems of present cover or liner products that do not include an adhesive backing or non slip bottom is that the cover or liner shifts and lifts from the surface of the article to be covered while items stored on the shelf are positioned or removed therefrom. Cover or liner products that include a pressure sensitive adhesive are difficult to position correctly on the shelf and are difficult to remove. The adhesive discourages removal of the cover liner when replacement is desired, or upon removal, a portion of the adhesive is left on the surface of the shelf. Additionally, present adhesive backed shelf coverings that are labeled removable may lose their removable characteristics after repeated applications and gather dirt and lint on their adhesive surfaces.

### SUMMARY OF THE INVENTION

It is the principle object of the invention to provide a covering or liner which overcomes the deficiencies of the prior art.

Another object of the invention is to provide a shelf liner material which is easy to install onto a shelf, yet includes a non-slip backing.

Still another object of the invention is to provide a shelf liner material which is thick enough to provide a durable surface while, at the same time, providing a decorative metal-like appearance.

In accordance with the present invention, there is provided an embossed, removable, non-slip, non-adhesive covering for a supporting surface. The covering includes a substrate having a top surface and a bottom surface, wherein at least a portion of the bottom surface comprises a non-slip, non-adhesive surface. The covering also includes a thick (8 mils, 0.2 mm) vinyl film having a color on one side resembling a metal, adhered (on the opposite side) to the top surface of the substrate, wherein when the non-slip bottom surface of the substrate is in contact with the supporting surface, the covering resists slipping laterally relative to the supporting surface The covering further includes a clear polypropylene protective layer adhered to the vinyl film.

In accordance with another aspect of the present invention, there is provided an embossed, adhesive, covering for a supporting surface. The covering includes a substrate having a top surface and a bottom surface, wherein at least a portion of the bottom surface comprises an adhesive surface. The covering also includes a thick (8 mils, 0.2 mm) vinyl film having a color on one side resembling a metal, adhered (on the opposite side) to the top surface of the substrate, and a clear polypropylene protective layer adhered to the vinyl film, wherein when the adhesive bottom surface of the substrate is in contact with the supporting surface, the covering is fixed to the supporting surface. The adhesive surface can have either a permanent type adhesive or a removable type adhesive.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof and wherein:

FIG. 1 is a top plan view, partially cut away to reveal layers of a portion of a removable, non-slip, non-adhesive covering in accordance with the invention;

FIG. 2 is a sectional side view of the shelf covering of FIG. 1, showing details of the laminated elements, in accordance with the invention;

FIG. 3 is a top plan view, partially cut away to reveal layers of a portion of an alternate adhesive covering in accordance with the invention;

FIG. 4 is a sectional side view of the shelf covering of FIG. 3, showing details of the laminated elements, in accordance with the invention; and

FIG. 5 is a schematic depicting a manufacturing process in accordance with the invention.

### DESCRIPTION OF THE PREFERRED EMBODIMENT

Reference is now made to the drawings wherein the showings are for the purpose of illustrating a preferred embodiment of the invention only and not for the purpose of limiting same. The present invention comprises an embossed film simulating a metallic finish, with adhesive or without adhesive or laminated to a bottom non-slip surface, for lining shelves and drawers.

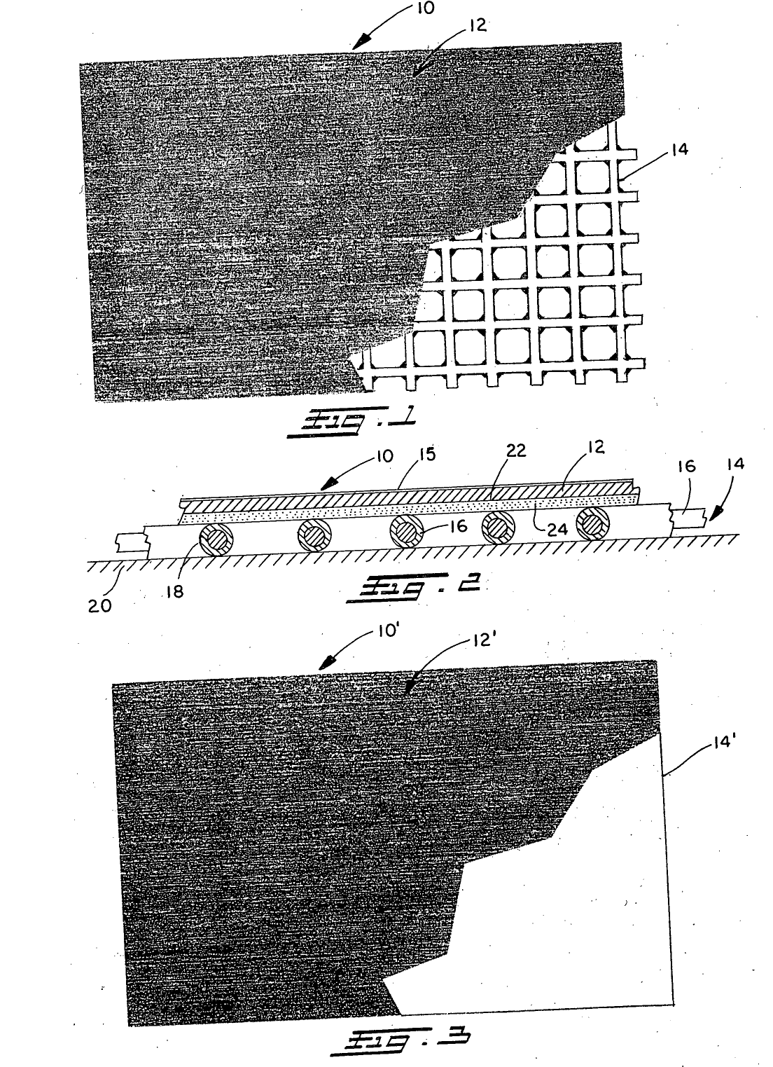

Referring to FIG. 1, the decoratively embossed, removable, non-slip, non-adhesive covering 10 of a preferred embodiment of the present invention includes an embossed film 12, embossed to simulate a metal surface as shown in the FIG., adhered to a substrate 14. In the preferred embodiment, a clear polypropylene protective layer 15 is adhered to the top surface of the film prior to embossing and protects the surface finish which is applied to the top of the film prior to affixing the polypropylene layer 15. The polypropylene protective layer 15 is transparent and the top of the film 12 is smooth prior to embossing. The body of the protective layer 15 protects the embossed faux metallic look. The polypropylene protective layer 15 is typically less than 1 mil (0.025 mm) in thickness. The substrate 14 preferably is made from a woven scrim, shown in FIG. 1, or a non-woven scrim. A preferred substrate is a plastic scrim and may have a plurality of apertures. The substrate has a top and bottom surface and at least an effective portion of the bottom surface is a non-slip, non-adhesive surface. That is to say, the bottom surface of the substrate 14 inhibits, but does not completely prevent, slipping or sliding on a supporting surface. Since the substrate 14 is non-adhesive, the cover 10 will not adhere to the supporting surface on which it is placed and may be lifted from the surface with little effort. The non-slip nature of the substrate 14, while inhibiting lateral movement along the supporting surface, does not completely prevent such movement so that the cover 10 may be repositioned as desired. Thus, the non-slip effective portion is sufficient to inhibit or hinder undesired slipping or sliding of the covering tangentially along the supporting surface during normal use.

Typically, the scrim is made non-slip by coating at least a portion of, and preferably the entire bottom surface, with a non-slip material or a material which can become non-slip upon subsequent treatment such as, for example, curing. Referring now to FIG. 2, the substrate 14 includes a non-slip coating 16 The non-slip coating 16 is preferably made from a cured polyvinyl chloride resin and is applied to at least a portion of the bottom surface of the substrate 14 in a conventional manner to provide an exposed outer surface 18 having a high coefficient of friction. The non-slip coating can be applied to the entire substrate surface or to any appropriate portion(s) thereof, as well. It is this high friction coated bottom surface 18 which will contact a support surface 20 and help to inhibit or hinder lateral displacement of the cover 10 with respect to the support surface 20. The non-slip coating may be applied in a continuous conformation or may be discontinuous such as, for example, in spaced or random strips, discrete islands, or the like.

Alternately, the non-slip layer may be a continuous flat sheet layer.

The preferred substrate 14 is a woven plastic scrim having a cured polyvinyl chloride resin non-slip coating 16. Such a substrate is commercially available from Henkel Consumer Adhesives, Inc., 32150 Just Imagine Drive, Avon, Ohio.

The embossed film 12 includes a back surface 22 which is adhered to the top surface 18 of the substrate as shown in FIG. 2. Preferably, the embossed film is adhered with an adhesive 24 such as, for example, a PVC adhesive. Examples of suitable adhesives include, but are not limited to, Henkel Nos. 3A-5416, 3B-5416, and 3C-5416 which are available from Henkel Adhesives, 1347 Gasket Drive, Elgin, Ill. 60120.

The textured, embossed film 12 of FIG. 1 is preferably made of a vinyl material that is thick enough for embossing a realistic metal-like finish and simultaneously suitable for covering a supporting surface such as, for example, a shelf surface. For example, prior art shelf coverings typically use a 3-5 mil sheets, whereas the above-described preferred embodiment utilizes a much thicker 8 mil (0.2 mm) embossed vinyl sheet. The embossed film can be other suitable materials known in the art provided the material is non-porous, waterproof and thick enough to be embossed with the metal-like finish. The embossed pattern is a combination of coloring and texturing which makes a non-metal surface look like a brushed metal surface. Such surface finishes are commercially available. The preferred vinyl material is suitable for incidental food contact while also providing a convenient surface for sliding articles such as, for example, dishware and china.

The covering 10 is preferably flexible and can be rolled or folded, although a rolled configuration is preferable. The covering can also be cut to the desired dimensions, such as, for example, those of the supporting surface without losing its non-slip, non-adhesive properties and without destroying the integrity of the cover.

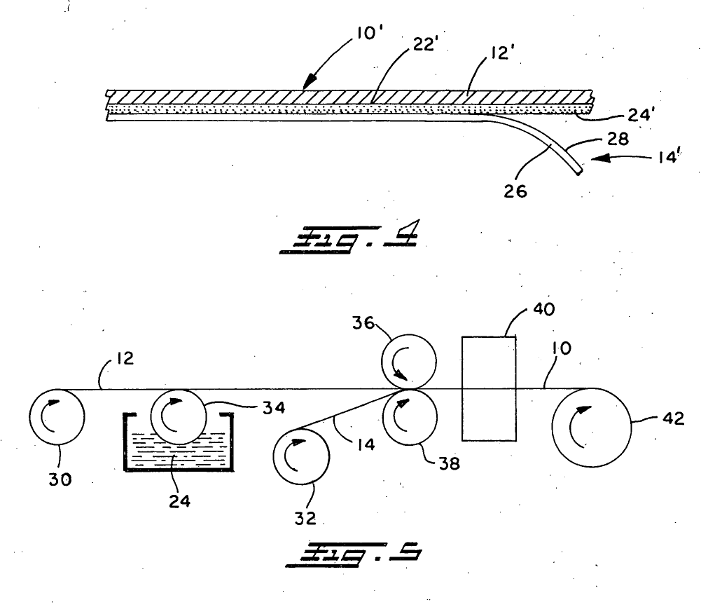

Referring now to FIG. 3, an alternate embodiment of the decoratively embossed, removable, non-slip, non-adhesive covering is shown. In the alternate embodiment, like numerals are used with a prime to refer to like features of the preferred embodiment. Thus, covering 10′ of the alternate embodiment of the present invention includes an embossed film 12′, likewise embossed to simulate a metal finish, covered with a clear polypropylene protective layer 15′, and adhered to a substrate 14′. The substrate 14′, however, comprises an adhesive backing including a removable protective covering 26 as shown in further detail in FIG. 4. The protective covering 26 is preferably a paper material that may be peeled back from the adhesive 24′ as shown in the FIG. The top surface 28 of the protective covering that is in contact with the adhesive 24′ is preferably coated so that it does not adhere permanently to the adhesive 24′ and may be easily peeled back from the adhesive. The cover is cut to a desired size and shape, if necessary, the protective covering is removed and the cover is placed on a supporting surface to which it adheres. Because the embossed film 12′ is relatively stiff, due at least in part to its thickness, the adhesive 24′ is preferably an aggressive adhesive to prevent the protective covering 26 from bubbling or rippling when the covering 10′ is bent or packaged in a rolled configuration.

FIG. 5 illustrates in schematic form a manufacturing process for securing the embossed film 12 to the substrate 14 using an adhesive 24 for the preferred embodiment as illustrated in FIGS. 1-2. The embossed film 12 is provided on a first feed roll 30 with the decorative embossed finish facing away from the roll 30, facing toward the top side of the figure as the embossed film is drawn from the roll 30. The substrate 14 is provided on a second feed roll 32. The adhesive 24 is coated onto one side of the embossed film 12 by means of a transfer roll 34 or other conventional means. The thickness of the adhesive can be controlled by the viscosity of the adhesive 24 applied to the roll 34 or other known means such as a doctor bar or doctor roll. The adhesive coated embossed film 12 and the substrate 14 are joined at pinch rollers 36, 38 where the layers are pressed together. The combined layers are pulled through a drying oven 40 where the adhesive is cured and the finished cover 10 is taken up on a take-up roll 42.

It may be desirable to coat the adhesive 24 onto the substrate 14 rather than the embossed film 12. In such a case, the substrate 14 is placed on the first feed roll 30. The decorative embossed film 12 is placed on the second feed roll 32 with the embossed finish placed facing the roll 32, facing toward the bottom side of the figure as the embossed film is drawn from the roll 32. In this setup, the drying oven 40 may be moved to a position between the transfer roll 34 and the feed roll 32 so that the adhesive may dry prior to the substrate 14 and the embossed film being pinched together at the pinch rollers 36, 38. Also, in this setup, the adhesive 24 can replace the anti-slip coating 16 provided that the adhesive has the desired anti-slip properties after curing in the drying oven 40.

The above-described manufacturing process can also be used to manufacture the alternate embodiment illustrated in FIGS. 3-4, however, in the first-described setup, the substrate 14′ should be placed on the roll 32 with the top surface 28 of the removable protective covering 26 facing up, away from the roll 32. In the second setup which is preferred for the alternate embodiment, as described in the previous paragraph, the substrate 14′ is placed on the roll 30 with the top surface 28 of the removable protective covering 26 placed facing down, toward the roll 30.

The embossed film 12 may be treated using any conventional machine to emboss a pattern or design, such as the metal-like finish for example, on a surface of the film. Such embossed film can be purchased or manufactured as part of making the subject product. This can occur before, during or after the joining process at the pinch rollers 36, 38, however, the embossing treatment is preferably performed after curing in the drying oven.

The invention has been described with reference to a preferred embodiment. The invention has also been described with respect to several alternate embodiments. These and other variations and modifications of the invention will occur to others upon the reading and understanding of this specification. It is intended that all such variations, alterations and modifications, be included insofar as they come within the scope of the appended claims or the equivalents thereof.

1. An embossed, removable, non-slip, non-adhesive covering for a supporting surface, said covering comprising
(a) a substrate having a top surface and a bottom surface, wherein at least a portion of said bottom surface comprises a non-slip, non-adhesive surface;
(b) a vinyl film having a color finish on one side resembling a metal adhered on the opposite side to said top surface of said substrate; and
(c) a clear polypropylene protective layer adhered to said vinyl film, wherein when said non-slip bottom surface of said substrate is in contact with said supporting surface, said covering resists slipping laterally relative to said supporting surface.

2. The covering as set forth in claim 1, wherein said embossed covering is embossed after said clear polypropylene protective layer is adhered to said vinyl film.

3. The covering as set forth in claim 1, wherein said vinyl film has a thickness of 8 mils (0.2 mm).

4. The covering as set forth in claim 1, wherein said substrate comprises a woven scrim.

5. The covering as set forth in claim 4, wherein said substrate comprises a woven plastic scrim.

6. The covering as set forth in claim 1, wherein said scrim comprises a non-woven scrim.

7. The covering as set forth in claim 1, wherein said substrate is coated on at least said bottom surface with a non-slip cured polyvinyl resin.

8. The covering as set forth in claim 7, wherein said polyvinyl resin comprises a polyvinyl chloride resin.

9. The covering as set forth in claim 1, wherein:
said substrate comprises at least one of:
a woven polyester scrim;
a non-woven nylon scrim; and
a punctured polyolefin film; and
at least a portion of said bottom surface of said scrim is coated with a non-slip cured polyvinyl chloride resin.

10. The covering as set forth in claim 1, wherein said covering is suitable for incidental food contact.

11. The covering as set forth in claim 1, wherein said vinyl film is adhered to said top surface of said substrate with an adhesive.

12. An embossed, adhesive covering for a supporting surface, said covering comprising
(a) a substrate having a top surface and a bottom surface, wherein at least a portion of said bottom surface comprises an adhesive surface; and
(b) a protective removable covering adhered to said top surface, wherein said removable covering can be peeled back and removed by a user;
(c) a vinyl film having a color finish on one side resembling a metal adhered on the opposite side to said top surface of said substrate; and
(d) a clear polypropylene protective layer adhered to said vinyl film, wherein when said adhesive surface of said substrate is in contact with said supporting surface, said covering is fixed to said supporting surface.

13. The covering as set forth in claim 12, wherein said embossed covering is embossed after said clear polypropylene protective layer is adhered to said vinyl film.

14. The covering as set forth in claim 12, wherein said vinyl film has a thickness of 8 mils (0.2 mm).

15. The covering as set forth in claim 12, wherein said covering is suitable for incidental food contact.

16. The covering as set forth in claim 12, wherein said vinyl film is adhered to said top surface of said substrate with an adhesive.

17. A method for covering a supporting surface, the method comprising contacting he non-slip bottom surface of a covering as defined in claim 1 with a surface of said supporting surface to be covered.
